(19) United States
(12) Patent Application Publication
(10) Pub. No.: US 2015/0363063 A1
(43) Pub. Date: Dec. 17, 2015

(54) APPARATUS AND METHOD OF DELIVERING CONTENT BETWEEN APPLICATIONS

(71) Applicant: Samsung Electronics Co., Ltd., Suwon-si (KR)

(72) Inventors: Mee-sun SONG, Yongin-si (KR); Seo-young KIM, Seoul (KR); Jin-suk LEE, Suwon-si (KR)

(73) Assignee: Samsung Electronics Co., Ltd., Suwon-si (KR)

(21) Appl. No.: 14/836,474

(22) Filed: Aug. 26, 2015

Related U.S. Application Data
(63) Continuation of application No. 12/563,600, filed on Sep. 21, 2009, now abandoned.

(30) Foreign Application Priority Data
Jan. 6, 2009 (KR) 10-2009-0000808

(51) Int. Cl. G06F 3/0486; G06F 9/445; G06F 3/0484

(52) U.S. Cl. CPC G06F 3/0486; G06F 3/04842; G06F 8/61

(57) ABSTRACT

Disclosed are an apparatus and a method of delivering content between applications. Content which is to be delivered from a source application to a target application may be extracted according to a user input signal, a content type describing object and a content extraction scheme corresponding to a content type. For example, the source application may be a web application including information received through a network, and the target application may be a local application which is executed using information stored in the apparatus, and vice versa.

### CROSS-REFERENCE TO RELATED APPLICATION

This application is a continuation of U.S. application Ser. No. 12/563,600, filed on Sep. 21, 2009, which claims the benefit under 35 U.S.C. §119(a) of Korean Patent Application No. 10-2009-0000808, filed on Jan. 6, 2009, the disclosure of which is incorporated herein by reference in its entirety for all purposes.

### BACKGROUND

1. Field

The following description relates to computing, and more particularly, to an apparatus and a method of delivering content between applications.

2. Description of the Related Art

As mobile devices have been improved in terms of computing power and display resolution, full browsing and multi tasking are implemented in such mobile devices. In addition, a semantic web technology has changed the concept of a web from simple links between documents into a set of information. Compared to a current web in which a user searches for desired information using a mouse or a keyboard to see and understand the web, a semantic web is provided in a computer understandable format, allowing machines to communicate with each other. However, since a large amount of information exists on the web, a method of allowing a user to easily store and use such a large amount of information needs to be developed.

### SUMMARY

According to one aspect, there is provided an apparatus for delivering content between applications, the apparatus including a user interface to receive a user input signal for delivering content from a source application, a content transfer manager to detect the content, which is to be delivered from the source application, among contents according to the user input signal by using a content type describing object which defines the content to be extracted and a content extraction scheme corresponding to a content type, and a controller to deliver the content extracted from the source application to a target application.

The content type describing object may include content type information, a function describing a scheme of detecting content corresponding to the content type, and a function describing a scheme of extracting information contained in the content.

The content type describing object may further include a presentation code function to provide a code for presentation of the delivered content, and the controller may display the delivered content on the target application using the presentation code function.

The content may include at least one of text, audio, an image, a widget, a microformat, and a java scripter library.

The content type describing object may be newly registered or deleted.

The user input signal may be a signal to execute a drag and drop operation or a copy and paste operation.

The content transfer manager may install or uninstall the content delivered to the target application.

The controller may create user interface feedback information to display a process of delivering the content extracted from the source application to the target application and provide the user interface feedback information.

The source application may be a web application including information received through a network, and the target application may be a local application which is executed using information stored in the apparatus, and vice versa.

According to another aspect, there is provided a method of delivering content between applications, the method including receiving a user input signal used to deliver content from a source application, extracting content which is to be delivered from the source application among contents according to the user input signal by using a content type describing object which defines the content to be extracted and a content extraction scheme corresponding to a content type, and delivering the content extracted from the source application to a target application.

Other features and aspects will be apparent from the following description, the drawings, and the claims.

### BRIEF DESCRIPTION OF THE DRAWINGS

FIG. 1 is a block diagram illustrating an example of an apparatus for delivering content between applications.

FIG. 2 is a diagram illustrating an example of delivery of content.

FIG. 3 is a diagram illustrating a content type describing object.

FIG. 4 is a flowchart illustrating an example of method of delivering content between applications.

FIG. 5 is a flowchart illustrating an example of method of registering a content type.

FIG. 6 is a flowchart illustrating an example of method of installing content.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terms “content” and “content type describing object” may be explained and/or defined as follows.

Content is information such as text, audio, and/or an image, which may be produced, processed and distributed in a digital scheme suitable for a wired/wireless communication network. Content may be categorized by a predetermined standard. Different types of content may include a widget, a microformat, a java scripter library, and the like.

Microformat is an information formatting scheme, in which information is processed in the form of metadata by using a predetermined markup which is used in an information set, such as a web page, based on, for example, an HTML (HyperText Markup Language) or an XHTML (Extensible HTML). If the microformat is applied to a normal web page based on the HTML, a program such as a web crawler may recognize additional information contained in the web page. Examples of such a microformat may include an Hcard which describes phone information, an HCalendar which describes schedule information, and the like.

A content type describing object is data, in which one or more processes used to deliver content between applications corresponding to types of content may be defined. The content type describing object may include content type information, a function describing a scheme of detecting a content type, and a function describing a scheme of extracting information included in content. Such content type information may be provided as identification information or name information that represents the content type. The content type describing object may further include a representative feedback image, which is used when delivering the content, or a function providing a presentation code which represents delivered content after the content has been delivered. Such a content type describing object may be stored in an additional storage and used.

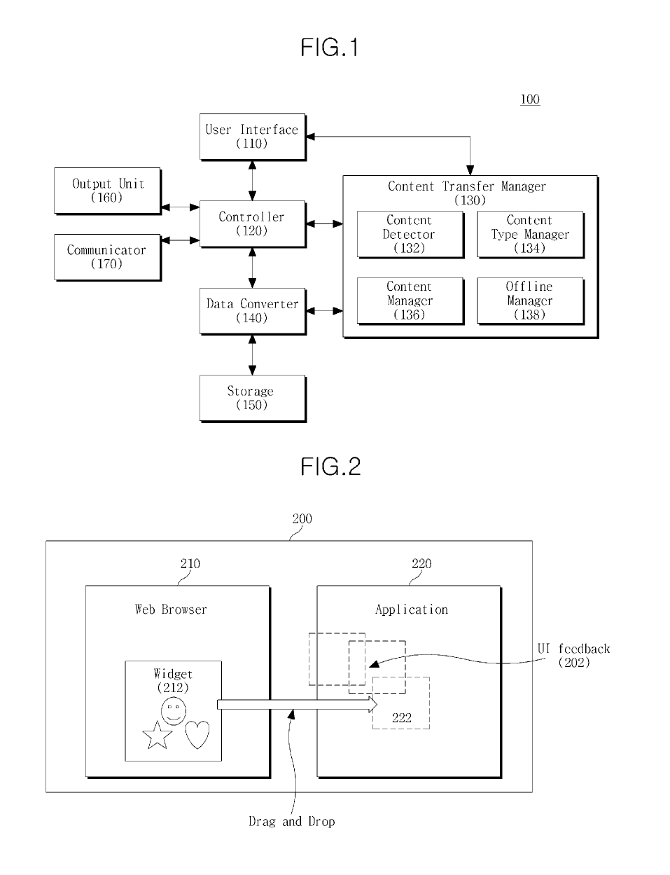

FIG. 1 illustrates an example of an apparatus 100 for delivering content between applications.

The content delivering apparatus 100 includes a user interface 110, a controller 120, a content transfer manager 130, a data converter 140, a storage 150, an output unit 160, and a communicator 170. The content delivering apparatus 100 may be realized in a various form of terminal device such as a mobile phone, a Personal Digital Assistant (PDA), a portable/personal multimedia player (PMP), a handheld e-book, a global positioning system (GPS) navigation, a portable game console, a digital camera, a MPEG-1 Audio Layer 3 (MP3) player, and the like.

The user interface 110 receives a user input signal and transfers the user input signal to the controller 120 and provides the user with results of operations by the controller 120. The user interface 110 may be provided in the form of an input/output device including a mouse, a keypad, a touch pad, and the like.

The controller 120 controls respective components 110 through 170 of the content delivering apparatus 100, and controls data transmission/reception between the components 110 through 170.

The content transfer manager 130 manages content transfer between applications. An application from which content is delivered may be referred to as a source application, and an application to which the content is delivered may be referred to as a target application. The source application and the target application may execute heterogeneous functions. As an example, the source application may be a web application including information received through a network, and the target application may be a local application which is executed using information contained in the content delivering apparatus 100, and vice versa.

The content transfer manager 130 performs a content transfer management in a manner to detect the content, which is indicated by the user input signal, from the source application. When the content is referred to as being detected, this may mean that content corresponding to the content type included in the content type describing object is detected together with actual data included in the content. For example, if the content type is an address book, content is detected together with contact information included in the address book.

The controller 120 delivers the content between the applications according to an operation of the contents transfer manager 130, for example, according to content detection, content type management, and content management of the content transfer manager 130. When the content is referred to as being delivered, this may mean that content corresponding to the content type is delivered together with actual data included in the content. If the content is delivered, the target application can manipulate and display the delivered content in its own shape.

The data converter 140 converts the content corresponding to a data storage architecture of the storage 150 when storing the content in the storage 150. The data converter 140 serializes or deserializes the content. The data converter 140 may perform encryption/decryption with respect to the content for the purpose of security.

The storage 150 may store programs and data that are used to operate the content delivering apparatus 100. In addition, the storage 150 may store the content type describing object and the content transferred from the source application to the target application. The output unit 160 may include an audio output unit and an image output unit. The communicator 170 may perform data transmission/reception with an external server by using a web application such as a web browser which may be executed in the content delivering apparatus 100.

In the example of a content delivering apparatus 100 shown in FIG. 1, the content transfer manager 130 includes a content detector 132, a content type manager 134, a content manager 136, and an offline manager 138.

The content detector 132 detects content, which is to be delivered from the source application, among contents selected based on a user input signal by using a content type describing object which defines the content to be extracted and a content extraction scheme corresponding to the content type. The content which is selected based on the user input signal may be determined by the source application. For example, when a web browser serves as the source application, if an event used to select content, for example, a drag operation is detected, a node of a Document Object Model (DOM) tree indicated by the drag operation is inspected, and content included in the inspected node or a parent node of the inspected node are extracted as meaningful content. Information about the extracted content is supplied as information regarding the content selected based on the user input signal to the content detector 132.

The content type manager 134 manages the content type describing object. For example, the content type manager 134 may register and delete the content type describing object. The content type describing object may be used to recognize and extract content to obtain data, until the content type describing object is deleted.

The content type describing object may be provided from the system, and registered through an application or a web in real time. For example, if information, which includes a function representing a content extraction scheme corresponding to a new content type and a function used to extract information included in content, is received through the user interface 110, the content type manager 134 creates the content type describing object using the input information. The content type describing object is converted in a predetermined form, which is suitable for storage in the storage 150, through the data converter 140 and then stored in the storage 150.

The content manager 136 controls installation, uninstallation and a life cycle of content downloaded by the user. If content delivered by the controller 120 is inserted into the target application, the inserted content may be installed by the content manager 136 and stored in the storage 150 in such a manner that the content installed in the target application is executed regardless of execution of the source application. For example, if the web application serves as the source application, content installed in the target application is available even when the web application is disconnected from an external network.

Content may be shared in a plurality of applications. In this case, even when the content is uninstalled from a certain application, the content manager 136 may prevent the other applications sharing the same content from being influenced by the application from which the content is uninstalled.

The offline manager 138 allows the content delivered from the web to be normally operated even when the content delivering apparatus 100 is disconnected from a network. For example, if an image file constituting content and a java script library used to execute the content is provided only as location information about a file existing on the web, the image file and the java script library are downloaded and stored on the content delivering apparatus 100 in advance such that the content is normally operated even if the content delivering apparatus 100 is disconnected from the network.

According to an example, content transfer is efficiently performed between, for example, different types of applications, so that the content is more easily operated in heterogeneous applications. The target application may easily share the content included in the source application without an additional code modification or compiling process. In a case that a web application serves as the source application and a local application serves as the target application, with the development of a semantic web, meaningful content is extractable from contents scattered on a web and the extracted content may be used in the local application.

For example, if a widget existing on a web page is dragged and dropped on a desktop of the content delivering apparatus 100, the widget is seamlessly installed on the desktop without having to install the widget. As an another example, if a banner of a web page is dragged and dropped on an address book application of the content delivering apparatus 100, contact information and address information regarding an advertiser included in the banner are automatically stored in the address book application. As still another example, if an icon instructing a java script library which is provided on the web and used to highlight dragged words is dragged and dropped on an e-book application of the content delivering apparatus 100, the java scripter library which has been implemented on the web performs the same function on the e-book as the web. The applicable content types are determined by the target application whether the application can interpret HTML, Java scrip library, and the like.

In addition, a local application may serve as the source application and a web application may serve as the target application. For example, when contact information about friends included in the address book of the content delivering apparatus 100 needs to be transferred to an acquaintance through a web mail, the contact information of the address book is transferred to a web mail application through a drag-and-drop operation without having to inputting each piece of contact information one by one, and thus the contact information is easily shared.

FIG. 2 illustrates example of a delivery of content.

As shown in FIG. 2, a screen 200 represents a display screen of the content delivering apparatus 100 on which a web browser 210 serving as a source application, and a target application 220 are executed. For example, if a user drags and drops a widget icon 212 onto an area of the target application 220, the widget icon 212 is delivered to the drop location of the target application 220 and displayed as a presentation 222. In order for the user to visually recognize a process of delivering the contents, the process may be represented through a user interface (UI) feedback 202.

Seeing the screen, the user can recognize that the widget icon 212 is delivered from the web browser 210 to the target application 220. The content delivering apparatus 100 detects content included in codes of the web browser indicated by the widget icon 212 based on a preset content type describing object, and inserts the detected content into the target application 220.

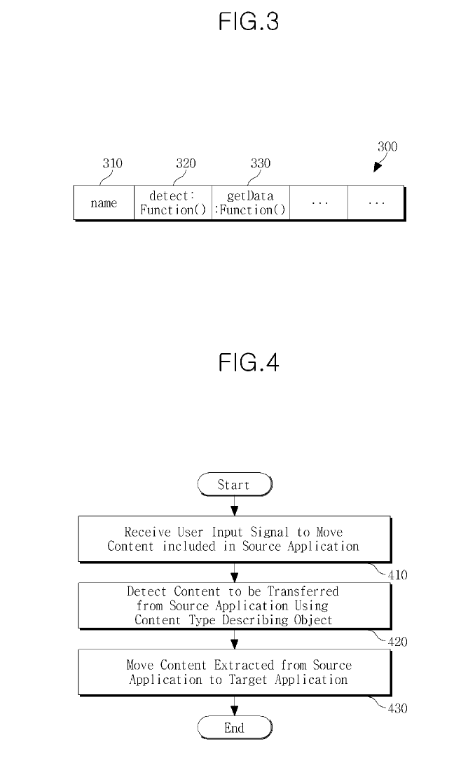

FIG. 3 illustrates an example of a content type describing object 300.

The content type describing object 300 includes content type information 310, a function (detect: function ( )) 320 describing a scheme of detecting a content type, and a function (getData: function ( )) 330 describing a scheme of extracting information included in content. If the content type is an address book, the information included in the content may include contact information and address information contained in the address book.

The content type describing object 300 may further include a function (getPresentationCode: function ( )) providing a presentation code for representing delivered content, a feedback image (_defaultFeedbackimage) used for a UI feedback, and a function (getFeedbackimge ( )) obtaining a feedback image used for the UI feedback from the detected content. The content type describing object 300 may further include various other functions for extracting and/or modifying various information corresponding to the content type.

FIG. 4 is a flowchart illustrating an example of a method of delivering content between applications.

Referring to FIGS. 1 to 4, the user interface 110 receives a user input signal to deliver content included in a source application (operation 410). For example, the user input signal may be a signal corresponding to a drag and drop operation or a copy and paste operation. It is understood that the user input signal may be another signal capable of selecting and locating contents on an application.

The content transfer manager 130 extracts content, which is to be delivered from the source application, among contents selected based on the user input signal by using the content type describing object which defines content to be extracted and a content extraction scheme corresponding to the content type (operation 420). For example, the source application may be a web application including information received through a network and the target application may be a local application which is executed using information stored in the content delivering apparatus 100, and vice versa. Information about the extracted content may be transferred to the controller 120 of the contents delivering apparatus 100.

The controller 120 delivers the content extracted from the source application to the target application (operation 430).

The controller 120 may create UI feedback information for informing a user of the delivery of the content and provide the UI feedback information through the output unit 160 such that the user can visually check the process of delivering the dragged content to the target application. The controller 120 may create the UI feedback information by using an icon image included in the content dragged by the user. If the dragged content do not include the icon image or if a preset feedback image is included in the content type describing object, the controller 120 may create the UI feedback information using the feedback image included in the content type describing object.

Also, after the content is delivered, the controller 120 may display a presentation, for example, an icon on a predetermined area of the target application by using the function (getPresentationCode: function ( )) which may be included in the content type describing object to provide a presentation code of the content.

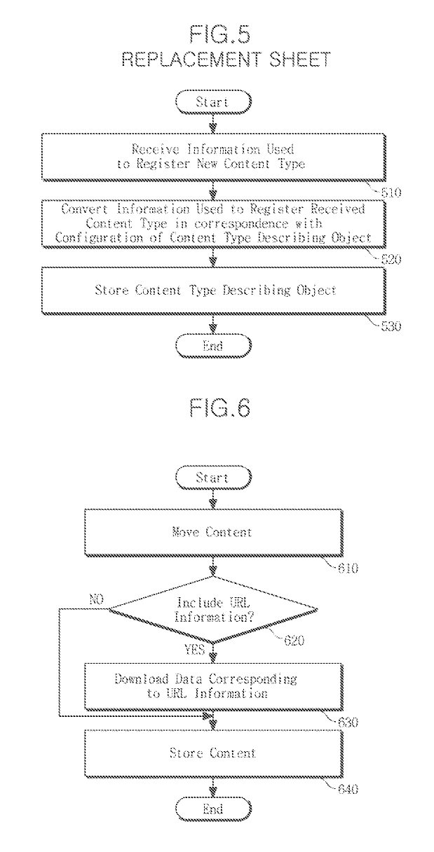

FIG. 5 is a flowchart illustrating an example of a method of registering a content type.

Referring to FIGS. 1 and 5, information used to register a new content type is received from the user interface 110 (operation 510). The content type manager 134 receives the information used to register a content type through the controller 120 and controls the data converter 140 such that the received information is converted according to a configuration of the content type describing object (operation 520).

Thereafter, the content type describing object is stored in the storage 150 (operation 530). The content type manager 134 may delete a specific content type describing object in response to a user input signal.

FIG. 6 is a flowchart illustrating an example of a method of installing content.

Referring to FIGS. 1 and 6, if a user input signal such as a drop operation used to deliver a content object to a target application is received, corresponding content is delivered, which has been described above with reference to FIG. 4 (operation 610).

The content manager 136 checks if the delivered content is stored in an external server, that is, if the delivered content includes Uniform Resource Locator (URL) link information (operation 620). If the delivered content is not stored in an external server, the content manager 136 stores the delivered content in the storage 150 (operation 640).

If the content is stored in an external server, data corresponding to the content is downloaded from a corresponding URL (operation 630). The content including the downloaded data is stored in the storage 150 (operation 640). In this case, since the information regarding the delivered content is downloaded and stored even if the content delivering apparatus 100 is disconnected from the network, the offline manager 138 normally executes the delivered content using the stored information and provides the content to the user.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

According to examples(s) described above, content may be more efficiently delivered between applications, allowing the content which has been executed in one application to be more easily delivered and operated in another application. A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus comprising:
a display; and
a processor operatively coupled with the display, the processor configured to:
perform a first application in a first region of the display, and a second application in a second region of the display;
select at least a portion of content displayed in the first region in response to an input; and
move the at least a portion of the content from the first region to the second region, the moving including presenting, via the display, an indication corresponding to the moving of the at least a portion of the content from the first region to the second region.

2. The apparatus of claim 1, wherein the processor is configured to:
perform the moving in response to another input.

3. The apparatus of claim 2, wherein the processor is configured to:
receive a drag and drop as the other input.

4. The apparatus of claim 1, wherein the processor is configured to:
extract data corresponding to the at least a portion of the content from the first application based at least in part on the selecting.

5. The apparatus of claim 1, wherein the processor is configured to:
present the at least a portion of the content or data corresponding to the at least a portion of the content based at least in part on a determination that the indication has been inserted into the second region.

6. The apparatus of claim 1, wherein the processor is configured to:
transmit the at least portion of the content or data corresponding to the at least portion of the content to an electronic device external to the apparatus based at least in part on a determination that the indication has been inserted into the second region.

7. The apparatus of claim 1, wherein the processor is configured to:
store the at least a portion of the content or data corresponding to the at least a portion of the content based at least in part on a determination that the indication has been inserted into the second region.

8. The apparatus of claim 1, wherein the processor is configured to:
receive data from an electronic device external to the apparatus using link information with respect to the content based at least in part on a determination that the indication has been inserted into the second region.

9. The apparatus of claim 1, wherein the indication comprises an image included in the at least a portion of the content, or a specified feedback image.

10. The apparatus of claim 1, wherein the content comprises text, or audio, an image, a widget, Hyper Text Markup Language(HTML), or any combination thereof.

11. A method comprising:
performing, at an electronic device, a first application in a first region of a display, and a second application in a second region of the display;
selecting at least a portion of content displayed in the first region in response to an input; and
moving the at least a portion of the content from the first region to the second region, the moving including presenting, via the display, an indication corresponding to the moving of the at least a portion of the content from the first region to the second region.

12. The method of claim 11, wherein the moving comprises:
performing the moving in response to a drag and drop.

13. The method of claim 11, wherein the moving comprises:
moving data corresponding to the at least a portion of the content from the first application to the second application.

14. The method of claim 11, wherein the selecting comprises:
detecting a content type corresponding to the at least a portion of the content.

15. The method of claim 11, further comprising:
presenting the at least a portion of the content or data corresponding to the at least a portion of the content based at least in part on a determination that the indication has been inserted into the second region.

16. The method of claim 11, further comprising:
installing, using data corresponding to the at least a portion of the content, an application or a widget based at least in part on a determination that the indication has been inserted into the second region.

17. The method of claim 11, further comprising:
storing the at least a portion of the content or data corresponding to the at least a portion of the content based at least in part on a determination that the indication has been inserted into the second region.

18. The method of claim 11, further comprising:
receiving data from link information with respect to the content based at least in part on a determination that the indication has been inserted into the second region.

19. The method of claim 11, wherein the indication comprises an image included in the at least a portion of the content, or a specified feedback image.

20. A non-transitory machine-readable storage device storing instructions that, when executed by one or more processors, cause the one or more processors to perform operations comprising:
performing, at an electronic device, a first application in a first region of a display, and a second application in a second region of the display;
selecting at least a portion of content displayed in the first region in response to an input; and
moving the at least a portion of the content from the first region to the second region, the moving including presenting, via the display, an indication corresponding to the moving of the at least a portion of the content from the first region to the second region.
